(19) United States
(12) Patent Application Publication
(10) Pub. No.: US 2014/0197968 A1
(43) Pub. Date: Jul. 17, 2014

(54) Vehicle Proximity Detection and Indication Devices and Methods

(71) Applicant: Jeffrey R. Mantie, Baldwinton (CA)

(72) Inventor: Jeffrey R. Mantie, Baldwinton (CA)

(21) Appl. No.: 13/952,789

(22) Filed: Jul. 29, 2013

Related U.S. Application Data
(60) Provisional application No. 61/752,657, filed on Jan. 15, 2013.

(51) Int. Cl. G08G 1/16

(52) U.S. Cl. CPC G08G 1/168
USPC 340/932.2

(57) ABSTRACT

A vehicle proximity sensor includes an indicator having a plurality of light sources arranged in series along a path. The light sources are in sequential groups, with each group featuring multiple light sources arranged to illuminate in a same common illumination colour that differs from the illumination colour of each other group. Considering the area being monitored to be divided into segments and subsegments, the latest color to be illuminated provides indication of the current segment reached by the vehicle, and a count of the light sources illuminated in said latest color provides indication of how far the vehicle has reached into the current segment. The sensor is mounted at bumper height, and linked by a flexible connector to a strip on which the light sources are mounted, which may be oriented to reach upward from the sensor location into the windshield site line of the vehicle.

### CROSS REFERENCE TO RELATED APPLICATIONS

This application claims benefit under 35 U.S.C. 119(e) of Provisional Application Ser. No. 61/752,657, filed Jan. 15, 2013.

### FIELD OF THE INVENTION

The present invention relates generally to vehicle proximity detection and indication systems providing users with visual feedback on the proximity between an object and an approaching vehicle, and more particularly to such a system with an proximity indicator with flexible, adaptable mounting options and a multi-stage lighting system employing sets of differently colored lights to indicate gradual movement through different stages of the approach.

### BACKGROUND OF THE INVENTION

It is known to employ systems for monitoring the distance between a stationary structure or object and an approaching vehicle and using a visual or audible indicator, or combination thereof, to provide the vehicle operator with feedback on this changing distance. For example, such a system can be employed in a home garage to monitor the distance between an end wall of the garage opposite the overhead garage door and the vehicle entering the garage through that door, and to signal the driver that they have pulled into the garage a suitable distance to avoid impact with the wall at one end of the vehicle, while bringing the other end of the vehicle fully into the garage to clear the opening of the overhead door and allow closing of same.

An example of one prior art system for such purposes is the vehicle proximity solution of U.S. Pat. Nos. 5,945,907 and 6,163,253 by Yaron et al. These patents teach an ultrasonic vehicle proximity detection system mounted on the wall of a garage to monitor the approach of a vehicle and provide visual feedback to the operator on when the vehicle has reached a predetermined distance from the wall. The indicator includes three differently colored lights that illuminate in series to provide the vehicle operator a staged approach warning to better indicate when they are at a safe, ‘close enough’ position to the wall.

However, a potential shortcoming of the solution is that the green, yellow, red sequence of the three lights provides only a fairly ‘low-resolution’ indicator of the vehicle's progress through the effective range of the detector. For example, while the yellow light is illuminated, indicating the vehicle is in a intermediate stage of the approach that precedes the final destination location indicated by the red light, there is no indication of how far through the ‘intermediate yellow zone’ the vehicle is at any given instant. The user must rely on an instantaneous light change from yellow to red as the signal to stop the vehicle. The reference mentions optional use of a digital display to also show the relative distance between the vehicle and the desired parking location, but this may introduce added complexity and cost by requiring two distinct types of displays, the colored lights and a separate digital read out. The patent also describes the sensor and indicator as being parts of an integrated unit, giving the user no adaptability in terms of mounting options and relative positioning of the sensor and indicator to suit the details of a particular application, for example based on a specific vehicle, or layout or contents of a specific garage.

U.S. Pat. No. 6,581,006 provides a vehicle proximity detection and indication system that may provide a more continuous indication of the approach, mentioning use of some green display segments for indicating a ‘safe distance’ between the vehicle and object, and some red display elements for indicating a ‘critical distance’ therebetween. However, the system is vehicle-mounted, particularly with the sensor mounted to the vehicle bumper, and the indicator mounted within the vehicle cabin for reading by the driver. The small-scale gradients of a dash-mounted vehicle display would not be suitable for a wall-mounted proximity sensor and indicator context like that of Yaron et al.

Accordingly, there remains room for improvement in the field of vehicle proximity detection and indication, and applicant has developed a new solution that addresses one or more shortcomings of the prior art, and may present other advantages or benefits.

### SUMMARY OF THE INVENTION

According to a first aspect of the invention there is provided a vehicle proximity sensing and indicating device comprising:

a proximity sensor arranged for mounting to an object from which proximity of an approaching vehicle is to be detected;

a controller linked to the proximity sensor and arranged to receive input signals therefrom that are reflective of proximity values detected thereby, and generate output responsive to said input signals; and

a proximity indicator linked to the controller and arranged to receive the output from said controller, the proximity indicator comprising a plurality of light sources arranged in a series along a path, the series comprising multiple groups of lights sources arranged one after the other along the path from a first end thereof to a second end thereof and each group of light sources comprising multiple light sources arranged to illuminate in a same common illumination colour, the common illumination colour being different for each group;

wherein the controller is arranged illuminate the light sources of the series in a sequential manner moving from the first end of the path toward the second end of the path as the input signals from the proximity sensor denote an increasing level of proximity detected thereby.

Preferably the proximity sensor is mounted in a sensor housing arranged for mounting on the object and the light sources of the proximity indicator are mounted on a light source carrier separate from said sensor housing.

Preferably said light source carrier is arranged for mounting separately of said sensor housing.

Preferably the controller is mounted in the sensor housing.

Preferably the light source carrier comprises a flexible strip.

Preferably said flexible strip comprises an adhesive backing on a rear side of said flexible strip opposite a front side of said strip to which the light sources are surface mounted.

Preferably the light sources comprise LED light sources that are visible over a 180-degree span arcing across the path along which the series of LED light sources are laid out.

Preferably there is provided a flexible connector arranged for connection of the proximity indicator to the proximity sensor via the controller.

Preferably the flexible connector is selected from a set of flexible connectors of varying lengths, each flexible connector being arranged for connection of the proximity indicator to the proximity sensor via the controller, whereby selection from among said flexible connectors allows placement of the proximity indicator at varying distances from the proximity sensor.

Preferably the proximity indicator has a length of at least 24-inches measured along the path on which the light sources are laid out in series.

Preferably the proximity indicator comprises at least twenty-four of said light sources in the series.

Preferably the proximity indicator comprises at least eight of said light sources in each group.

According to a second aspect of the invention there is provided a method of sensing and indicating proximity of a vehicle to a stationary reference location, the method comprising the steps of:

using a sensor mounted at the stationary reference location, automatically monitoring a proximity of the vehicle to the reference location as said vehicle approaches said reference location, and during said monitoring:
detecting that the vehicle has entered a first subsegment of a first segment of a defined space leading up to said reference location, and in response, illuminating a first light source of a series of light sources in a first colour at a visual indicator for providing vehicle operator feedback on the proximity of the vehicle to the stationary location;
for each of a number of additional subsegments of the first segment that combine with the first subsegment of the first segment to define the first segment of the defined space, detecting that the vehicle has entered said additional subsegment, and in response, illuminating a sequentially adjacent light source of the series of light sources in the first color;
detecting that the vehicle has entered a first subsegment of a second segment of the defined space, and in response, illuminating a sequentially next light source of the series of light sources in a second colour distinct from the first color; and
for each of a number of additional subsegments of the second segment, detecting that the vehicle has entered said additional subsegment, and in response, illuminating another sequentially next light source of the series of light sources in the second color;

whereby the latest color to be illuminated at the visual indicator provides indication of the current segment reached by the vehicle, and a count of the light sources illuminated in said latest color provides indication of how far the vehicle has reached into the current segment.

According to a third aspect of the invention there is provided a method of installing a vehicle proximity sensing and indicating device, the method comprising mounting a proximity sensor to an object from which proximity of an approaching vehicle is to be detected, and mounting a proximity indicator at a location that is visible from an approach to said object, wherein the step of mounting the proximity indicator comprises mounting the proximity indicator separately from the proximity sensor at a distance spaced therefrom.

According to a fourth aspect of the invention there is provided a method installing a vehicle proximity sensing and indicating device, the method comprising mounting the device to an object from which proximity of an approaching vehicle is to be detected with a proximity sensor of the device positioned at approximately a bumper height of the vehicle to be detected and a strip-shaped proximity indicator extending upwardly away from said proximity detector to a height readily visible from an operator cabin when the vehicle is sufficiently close to the proximity sensor to obscure said proximity sensor from site, wherein the proximity indicator comprises a plurality of light sources arranged in a series the strip one or the other for upwardly sequential illumination of the light sources in a colored pattern as the sensor detects increases in proximity of the vehicle to the object.

### BRIEF DESCRIPTION OF THE DRAWINGS

In the accompanying drawings, which illustrate exemplary embodiments of the present invention:

FIG. 1 is a schematic front perspective view of a detection and control unit of a proximity detector and indicator of the present invention.

FIG. 2 is a schematic front elevational view of an indication unit of the proximity detector and indicator of the present invention.

FIG. 3 is a schematic illustration showing the proximity detector and indicator of the present invention installed in a garage for use in positioning a vehicle in a suitable parking location close to, but spaced from, a wall on which the proximity detector and indicator is mounted.

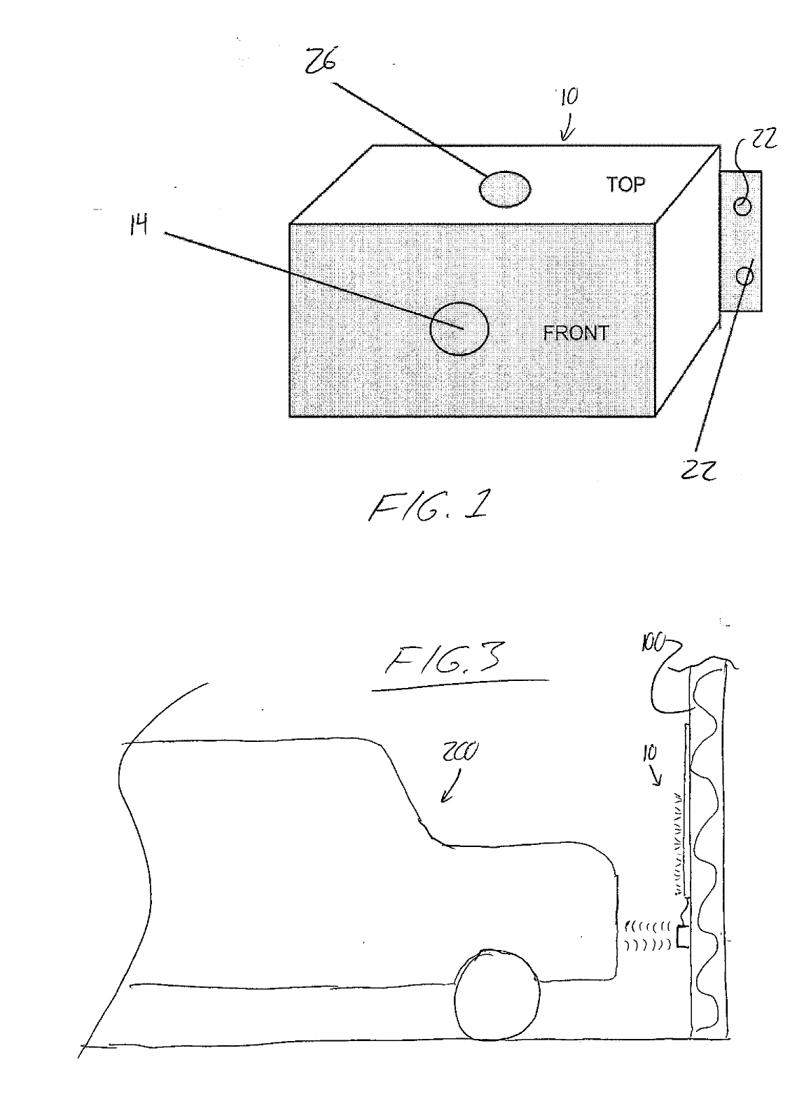

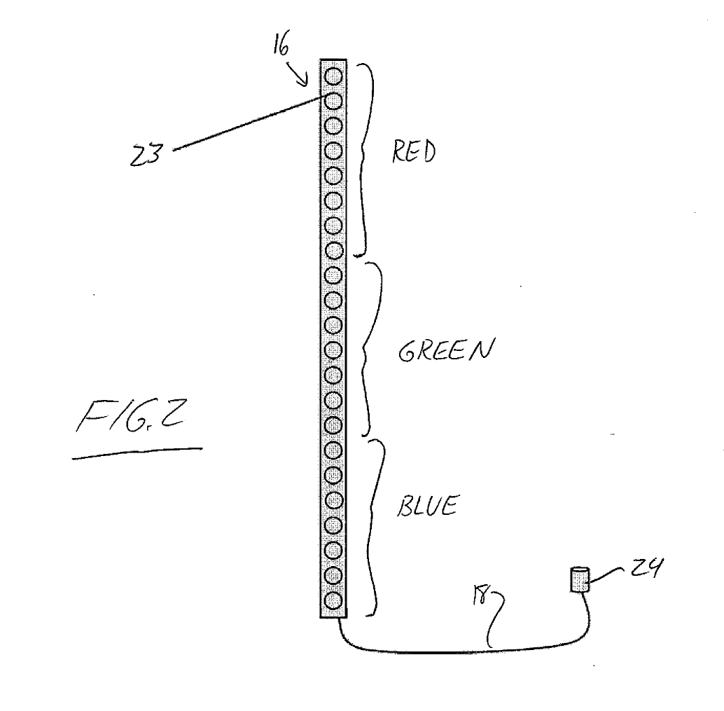

### DETAILED DESCRIPTION

The drawings illustrate a proximity sensing/detecting and indicating device of the present invention, also referred to herein as a range finder. In brief, the range finder is comprised of four main components: i) a sealed box or housing 10 for mounting to a structural garage wall 100 or other suitable stationary object; ii) a microcontroller 12 contained within the sealed housing 10; iii) an ultrasonic transceiver 14 also mounted in the sealed housing 10; and iv) an LED light bar or strip 16 that is separate and distinct from the sealed housing and connectable thereto by way of a flexible cable 18.

### Mounting

The range finder uses a flanged box for the sealed housing 10 so that it can easily be mounted to the wall of a garage or shop, or any other surface that would support its weight, by use of threaded fasteners engaged into the wall or other support through fasteners holes 20 in one or more flanges 22 projecting outward from the housing at a rear end thereof.

The transmitter and receiver of the ultrasonic transceiver 14 are operable to emit ultrasonic pulses, and receive returned reflections of those pulses, at a front end 10a of the housing opposite the flanged rear end thereof. With reference to FIG. 3, the sealed housing 10 of the range finder can be mounted to the wall 100 at an elevation corresponding to bumper level of a vehicle 200 expected to be parked in front of the wall. When mounting the sealed housing 10 according to a particular vehicle that is expected to be parked at such location on a regular basis, the optimal spot for mounting the housing 10 aligns with the flat point or area of the bumper where the license plate in the front or back of the vehicle is typically mounted. One can alternatively mount the range finder in an orientation that would bounce the ultrasonic waves off of the side of a vehicle to detect when a vehicle has pulled close enough to the wall to reach the intended parking location target.

The light bar or strip can be mounted in any orientation and in any position, and be connected to the sealed box 10 via the flexible cable 18, which may be a custom length cable, for example as selected by the installer from among a plurality of different cable lengths offered by the manufacturer, distributor or seller of the system. This way, the installer can tailor the position of the light bar or strip 16 relative to the housing 10 in order to best fit conditions of the particular application, for example based on available wall space for accommodating mounting of the separate components, the bumper height of the expected vehicle, the field of vision from the windshield or rear window of the expect vehicle, etc. Selection from among multiple cable lengths accommodates various positional relationships between the housing and the light bar or strip without leaving an excessive amount of slack that may result for some installations in the instance that a ‘one size fits all’ cable is alternatively used, having been supplied in a notable length chosen to cover an manufacturer-estimated maximum spacing between the housing and the light bar or strip.

The light bar or strip is preferably a flexible LED strip, featuring a flexible strip-shaped substrate that can curve at least in its longitudinal direction, which defines a path along which a plurality of surface mount LED units 23 are disposed one after the other in closely spaced positions substantially spanning the length of the strip. One embodiment of the present invention employs a commercially available flexible 1-meter long LED strip with 32 RGB LED units spaced therealong at 31.35-millimeter increments (model FLB-W5050RGB-16-5-A14 by RayConn Electronics Co., Ltd.). Another embodiment may employ an LED strip of 32-inch length with 32 LED units spaced therealong at even intervals. Preferably the LED strip has a minimum length of at least 24 inches, and at least 24 LED units, for example at least 8 LED's per color group or zone.

The LED strip of the prototype uses a four-pin connection 24 on the flexible connection cable 18 in order to connect to the microcontroller 12 in the housing 10 via a mating connection port 26 on the housing, for example at a top wall thereof. The flexible substrate of the strip features an adhesive backing on the rear face thereof opposite the LED units in order to stick the strip to the wall of the garage or shop, but alternatively can be fastened in place by other means, for example being taped or stapled to the wall. The use of a flexible strip allows flush mounting on surfaces that are not entirely planar, or mounting in a manner spanning between two separate surfaces that are not entirely coplanar with one another, thereby allowing a significant amount of adaptability to suit the conditions at any of a variety of installation locations. Use of an adhesively backed strip also eases the installation process by avoiding the need for separate external fasteners, and minimizing residual damage to the wall should the device later be removed.

### Operation

When the range finder is powered on, it first turns on all of the LED light units on the light strip or bar to signal that it is working correctly. It then begins emitting the ultrasonic pulses in a continuous fashion. It measures the time it takes to receive a response (echo) back from any target that the pulses are hitting. In the proposed application of the present invention, the intended target is a vehicle entering the garage, for example through an overhead door located opposite the wall 100 on which the range finder 10 is mounted, whereby the ultrasonic transceiver uses the timing of reflected signals from the leading bumper of the approaching vehicle (whether the rear bumper of a vehicle being reversed into the garage, or the front bumper of a vehicle being driven forwardly ‘head first’ into the garage) to gauge the distance between the vehicle and the range finder mounted on the wall, thus effectively measuring the distance from the wall to the approaching vehicle.

The following description of the proximity detection and indicating process carried out by the range finder is based on the use of a 32-inch distance as a predefined range of space spanning outward from the position of the range finder on the wall. This defines the operational range within which the range finder will control illumination of the LED light units in a manner giving visual indication of the vehicle's position within this range of space at a given moment so that the driver gets visual feedback on how close the vehicle is to wall, from which they can determined whether they've reached a suitable parking position. It will be appreciated that this particular 32-inch range is presented as an example only, and that the range finder may be pre-configured for a different predetermined range, or may be configured to use a user-programmable/selectable range value. Similarly, the following description uses division of this 32-inch range into three segments, each of which is further divided into smaller 1-inch subsegments, but it will be appreciated that the values of these divisions may likewise vary from these examples.

The microcontroller and the LED bar or strip are configured with one another so that the colors in which the LED units are illuminated are arranged in sequential groups arranged in order from the first LED unit nearest the bottom end of the strip to a last LED unit nearest the top end of the strip. A first group of the LED units includes the first unit and spans up several units, for example to a twelfth LED unit in the series, and these first twelve LED units are arranged to all illuminate in a same first color, for example blue. A second group of the LED units includes the thirteenth unit and spans up several units, for example to a twenty-fourth LED unit in the series, and these second twelve LED units are arranged to all illuminate in a same second color, for example green. Finally, a third group of the LED units includes the twenty-fifth unit and spans up to the final thirty-second LED unit in the series near the top of the strip, and these third eight units are arranged to all illuminate in a same third color, for example red.

In this manner, each LED unit corresponds to a respective subsegment of the overall range of space being monitored, and the through the grouping of different LED illumination colors, the range of space is also divided into a first segment spanning 12-inches from a point 32-inches out from the range to finder to a point 20-inches from the range finder, a second segment spanning 12-inches from a point 20-inches out from the range to finder to a point 8-inches from the range finder, and a third segment spanning the last 8-inches to the range finder. If the range finder determines that a target vehicle is 32-inches away, it will illuminate the lowest (first) light on the light bar or strip. As a vehicle draws nearer and nearer to the range finder, the range finder continues to light up subsequent LEDs one at a time in correspondence to each inch of distance (i.e. each subsegment of the overall range) by which the vehicle moves closer to the range finder.

The first 12 LED units are illuminated sequentially in blue, but as the vehicle crosses the imaginary boundary of the first and second segments of the range (i.e. comes within 24-inches of the range finder), the next LED unit is illuminated in green, as are the next twelve sequentially illuminated LED units. As the vehicle comes within 8-inches of the range finder, the light bar starts illuminating the red lights to indicate that the vehicle is drawing close to the range finder and wall. The vehicle is able to come within 1-inch of the wall or sealed box before the range finder is unable to indicate a closer distance, as the last LED unit is illuminated when the vehicle reaches this distance. This may be considered the optimal spot for a vehicle to park, representing the position past which the driver will likely impact the wall.

Once the detected distance from the range finder to the vehicle has been static for a predetermined period of time, for example 10 seconds, the range finder turns off the light bar to conserve power, but the ultrasonic transceiver continues operation in order to monitor for subsequent changes in the vehicle position. This may for example be referred to as ‘parked mode’, where the static condition of the vehicle is interpreted as meaning that the vehicle has been parked, and the visual indication of the vehicle's position is thus no longer required.

Each LED unit illuminated in the above vehicle-approach routine is kept in its illuminated state until one of two events occurs, either until the 10-second static-position determination period has expired, at which time all illuminated LED units are deactivated, or until the sensor determines that the vehicle has now moved away from the wall past the segment of the range that is represented by the LED in question (i.e. that the current position of vehicle is further away from the wall than the segment of space represented by that LED).

Once the vehicle begins to pull away from the range finder, which therefore detects that the distance between the vehicle and range finder is changing again, it will re-illuminate the light bar and resume normal operation until the vehicle is detected as having left the garage or its readable range. That is, when the range finder detects change in the position of the vehicle after having previously entered ‘parked mode’, it illuminates all LED units from the first unit up to the LED unit reflecting the currently detected vehicle position. Moving sequentially downward back toward the first LED unit, each unit is deactivated (put in a non-illuminated state) one-by-one as the vehicle moves back (i.e. away from the wall) through the respective subsegments of the monitored range of space. Eventually the vehicle will leave the range of space entirely, triggering deactivation of the first (lowermost) LED unit. The sensor keeps operating however, to monitor for later return of the vehicle into the space.

While the above process makes reference to the bottom or lowermost LED unit as the ‘first’ in the series, it will be appreciated that this particular description is in reference to the illustrated vertical-mounting orientation of the LED bar or strip, but that the bar or strip may be mounted in other orientations, for example to instead extend longitudinally in a horizontal direction.

Ultrasonic proximity sensors, and LED illumination control responsive thereto via a microcontroller, are known in the art, and thus the further details on these components and their cooperation to achieve the above-described procedure are not disclosed herein.

The LED bar or strip of the prototype uses RBG LED units each having a red, blue and green LED at the respective position on the strip, whereby any of the LED units can be illuminated in any one of red, blue or green, or other colors created by mixtures thereof, and the microcontroller of the prototype is programmed to provide the above described grouping of illumination colors among the series of LED units. However, it will be appreciated that the LED bar or strip may alternatively be manufactured with an individual LED for each respective light source position along the strip, with LEDs of a respective common color thus being used in each group.

Light sources other than LEDs may similarly be arranged in color groups to achieve the same effect of using different colors to represent occupation of different zones or segments of the monitored space by the vehicle, while providing further positional detail in terms of progress through each zone or segment using individual light sources to mark subsegments or sub-zones of the space. However, LEDs have several advantages in being lightweight, compact, energy efficient, and mountable on a flexible printed circuit board (PCB) to form an overall flexible fixture that can be coiled for compact packing and shipping and can flex to suit a variety of mounting applications.

The aforementioned LED bar or strip of the prototype also provides significant ingress protection (IP) against environmental hazards, having an IP rating of 64, representing a dust-tight enclosure with splash protection in any direction. A transparent or highly translucent cover mounted over the LED units and associated components on the front surface of the PCB, whereby not only are the surface mount LED units protected, but are visible over a 180-degree span arcing across the longitudinal axis of the strip along which the series of LED units are spaced. As a result, the LED units are highly visible over a wide viewing angle and variety of viewpoints. In addition, the significant number of light sources used to provide a higher-resolution gauge of vehicle movement in the monitored space also results in a greater illumination effect, whereby the vehicle movement may trigger a substantial illumination of the garage or other space in which the device is used, thereby helping illuminate the vehicle's path of travel.

Although the use of a light bar or strip that is separate of the sensor housing provides the ability to mount the indicator unit in any of a variety of positions, the particular installation of FIG. 3 may present some notable advantage. Here, the light bar or strip is mounted in a position a short height above the sensor housing in a vertical orientation, for example at a position that may horizontally equal or closely match the horizontal position of the sensor housing on the wall. The sensor housing is mounted at bumper height below the hood line, trunk line or truck bed of the vehicle, and the light bar or strip extends upward from at or near the hood line up into or past the elevation range spanned by the windshield or rear window of the vehicle. This relative positioning of these components minimizes the overall footprint of the device on the wall, while the elongated shape and upright orientation of the light bar or strip ensures that at least the topmost group of LEDs are visible when the car has reached a suitable parking position. Even where some of the LEDs are positioned below the hood line, the driver's angle of sight over the leading end of the hood during earlier segments or zones of the approach may be sufficient to make these lower LEDs visible until the vehicle has past the corresponding subsegments of the monitored space.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A vehicle proximity sensing and indicating device comprising:
a proximity sensor arranged for mounting to an object from which proximity of an approaching vehicle is to be detected;
a controller linked to the proximity sensor and arranged to receive input signals therefrom that are reflective of proximity values detected thereby, and generate output responsive to said input signals; and
a proximity indicator linked to the controller and arranged to receive the output from said controller, the proximity indicator comprising a plurality of light sources arranged in a series along a path, the series comprising multiple groups of lights sources arranged one after the other along the path from a first end thereof to a second end thereof and each group of light sources comprising multiple light sources arranged to illuminate in a same common illumination colour, the common illumination colour being different for each group;
wherein the controller is arranged illuminate the light sources of the series in a sequential manner moving from the first end of the path toward the second end of the path as the input signals from the proximity sensor denote an increasing level of proximity detected thereby.

2. The device of claim 1 wherein the proximity sensor is mounted in a sensor housing arranged for mounting on the object and the light sources of the proximity indicator are mounted on a light source carrier separate from said sensor housing.

3. The device of claim 2 wherein said light source carrier is arranged for mounting separately of said sensor housing.

4. The device of claim 2 wherein the controller is mounted in the sensor housing.

5. The device of claim 2 wherein the light source carrier comprises a flexible strip.

6. The device of claim 5 wherein said flexible strip comprises an adhesive backing on a rear side of said flexible strip opposite a front side of said strip to which the light sources are surface mounted.

7. The device of claim 2 wherein the light source carrier comprises a flat strip and the light sources comprise LED light sources surface mounted on a face of said flat strip.

8. The device of claim 1 wherein the light sources comprise LED light sources that are visible over a 180-degree span arcing across the path along which the series of LED light sources are laid out.

9. The device of claim 1 comprising a flexible connector arranged for connection of the proximity indicator to the proximity sensor via the controller.

10. The device of claim 1 comprising a set of flexible connectors of varying lengths, each flexible connector being arranged for connection of the proximity indicator to the proximity sensor via the controller, whereby selection from among said flexible connectors allows placement of the proximity indicator at varying distances from the proximity sensor.

11. The device of claim 1 wherein the proximity indicator has a length of at least 24-inches measured along the path on which the light sources are laid out in series.

12. The device of claim 1 wherein the proximity indicator comprises at least twenty-four of said light sources in the series.

13. The device of any one claim 1 wherein the proximity indicator comprises at least eight of said light sources in each group.

14. A method of sensing and indicating proximity of a vehicle to a stationary reference location, the method comprising the steps of:
using a sensor mounted at the stationary reference location, automatically monitoring a proximity of the vehicle to the reference location as said vehicle approaches said reference location, and during said monitoring:
detecting that the vehicle has entered a first subsegment of a first segment of a defined space leading up to said reference location, and in response, illuminating a first light source of a series of light sources in a first colour at a visual indicator for providing vehicle operator feedback on the proximity of the vehicle to the stationary location;
for each of a number of additional subsegments of the first segment that combine with the first subsegment of the first segment to define the first segment of the defined space, detecting that the vehicle has entered said additional subsegment, and in response, illuminating a sequentially adjacent light source of the series of light sources in the first color;
detecting that the vehicle has entered a first subsegment of a second segment of the defined space, and in response, illuminating a sequentially next light source of the series of light sources in a second colour distinct from the first color; and
for each of a number of additional subsegments of the second segment, detecting that the vehicle has entered said additional subsegment, and in response, illuminating another sequentially next light source of the series of light sources in the second color;
whereby the latest color to be illuminated at the visual indicator provides indication of the current segment reached by the vehicle, and a count of the light sources illuminated in said latest color provides indication of how far the vehicle has reached into the current segment.

15. A method of installing a vehicle proximity sensing and indicating device, the method comprising mounting a proximity sensor to an object from which proximity of an approaching vehicle is to be detected, and mounting a proximity indicator at a location that is visible from an approach to said object, wherein the step of mounting the proximity indicator comprises mounting the proximity indicator separately from the proximity sensor at a distance spaced therefrom.

16. The method of claim 15 comprising selecting a suitable flexible connection for linking together of the proximity indicator and the proximity sensor from among a plurality of flexible connections of different lengths according to a length required for desired positions of the proximity sensor and the proximity indicator.

17. The method of claim 15 wherein the proximity indicator comprises a flexible strip on which are mounted a plurality of light sources arranged in a series along a path for sequential illumination of the light sources in a colored pattern as the sensor detects increases in proximity of the vehicle to the object.

18. The method of claim 17 comprising adhesively mounting the flexible strip for fastener-free installation of same.

19. The method of claim 15 comprising mounting the proximity sensor of the device and mounting a strip-shaped proximity indicator in a position extending upwardly away from said proximity detector to a height readily visible from an operator cabin when the vehicle is sufficiently close to the proximity sensor to obscure said proximity sensor from site, wherein the proximity indicator comprises a plurality of light sources arranged in a series the strip one or the other for upwardly sequential illumination of the light sources in a colored pattern as the sensor detects increases in proximity of the vehicle to the object.
